(19) United States
(12) Patent Application Publication
(10) Pub. No.: US 2021/0322970 A1
(43) Pub. Date: Oct. 21, 2021

(54) DROPLET EJECTORS TO MIX FLUIDS

(71) Applicant: HEWLETT-PACKARD DEVELOPMENT COMPANY, L.P., Spring, TX (US)

(72) Inventors: Pavel Kornilovich, Corvallis, OR (US); John Lahmann, Corvallis, OR (US); Alexander Govyadinov, Corvallis, OR (US)

(21) Appl. No.: 16/605,267

(22) PCT Filed: Jul. 17, 2018
(86) PCT No.: PCT/US2018/042416

§ 371 Date: Oct. 15, 2019

(51) Int. Cl. B01L 3/02; B01F 5/00; B01F 15/02

(52) U.S. Cl. CPC B01L 3/0268; B01F 5/0085; B01F 2215/0037; B01L 2300/0867; B01F 15/0246

(57) ABSTRACT

An example device includes a first droplet ejector including a first nozzle to eject droplets of a first fluid, a second droplet ejector including a second nozzle to eject droplets of a second fluid, and a target medium. The example device further includes a mixing volume positioned between the first and second droplet ejectors and the target medium. The mixing volume is to receive the droplets of the first fluid and the droplets of the second fluid, provide mixing of the droplets of the first fluid and the droplets of the second fluid, and provide a mixture to the target medium.

### BACKGROUND

Droplet ejection is used for a variety of purposes, such as printing ink to paper and dispensing of other types of fluid to a surface. Often a surface and a printhead that ejects fluid droplets to the surface are moved relative to one another.

### BRIEF DESCRIPTION OF THE DRAWINGS

FIG. 1 is a cross-sectional view of an example device with a mixing volume positioned between droplet ejectors and a target medium.

FIG. 2 is a cross-sectional view of an example device with a mixing volume positioned between droplet ejectors and a target medium and with fluid reservoirs that feed the droplet ejectors.

FIG. 3 is a cross-sectional view of an example device with funnel that defines a mixing volume between droplet ejectors and a target medium.

FIG. 4 is a cross-sectional view of an example device with a mixing volume positioned between droplet ejectors and a target medium that includes a further droplet ejector.

FIG. 5 is a cross-sectional view of an example device with a mixing volume positioned between droplet ejectors and a target medium that include a plurality of further droplet ejectors.

FIG. 6 is a schematic diagram of an example device with a mixing volume positioned between droplet ejectors and a target medium.

FIG. 7 is a schematic diagram of an example device with a plurality of stages of mixing between droplet ejectors and target media.

FIG. 8 is a schematic diagram of an example device with different stages of mixing between droplet ejectors and target media.

FIG. 9 is a schematic diagram of another example device with different stages of mixing between droplet ejectors and target media.

FIG. 10 is a schematic view of an example system including an example control device and an example cartridge including a mixing volume positioned between droplet ejectors and a target medium.

FIG. 11 is a perspective diagram of an example funnel to provide a mixing volume between droplet ejectors and a target medium.

### DETAILED DESCRIPTION

Different fluids may be overprinted or printed to the same location on a surface. However, overprinting or printing different fluids to the same location of a target medium may not provide sufficient mixing of the different fluids. Such techniques often rely on characteristics of the target medium to provide for mixing.

Inkjet-like droplet ejection may be used to mix chemical, biological, or biochemical material to deliver a mixture to a target medium. Such mixing includes aerosol mixing of droplets of different fluids. A mixing body, such as a funnel, may be provided to contain and direct ejected fluid droplets and any coalesced liquid mixture to a target region of a target medium. The droplet ejectors and the target medium may be combined in a consumable package, such as a cartridge. The target medium may be passive (e.g., paper) or active (e.g., a silicon die). Multiple stages of mixing may be implemented. Mixing may involve a reaction or may be a simple mixing of constituent ingredients.

A target medium may thus be provided with a mixture, instead of relying on the characteristics of the target medium to provide mixing. Further, mixing may be provided without moving parts at a scale larger than an individual droplet ejector, so as to provide a relatively high rate of mixture flow. In addition, a cartridge may be provided with constituent fluids and mixing may be controlled dynamically at time of use. A specific fluid, such as a sample, may be provided by the end user.

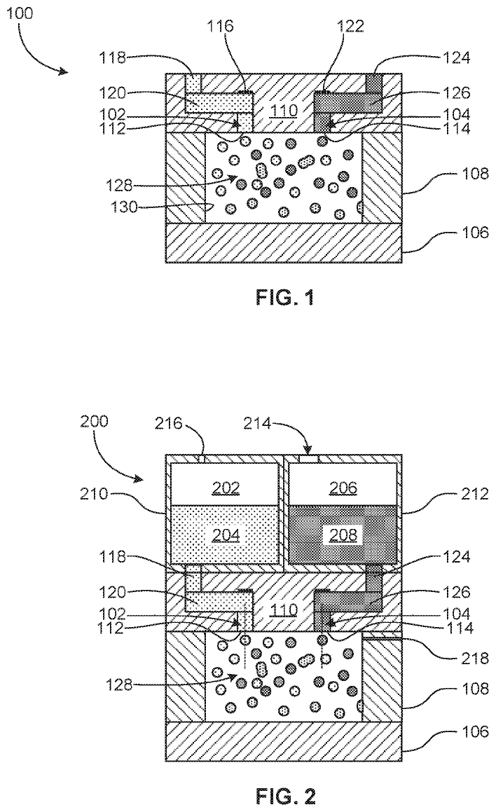

FIG. 1 shows an example device 100. The device 100 includes a first droplet ejector 102, a second droplet ejector 104, a target medium 106, and a mixing body 108. The mixing body 108 is positioned between the droplet ejectors 102, 104 and the target medium 106. The droplet ejectors 102, 104 may be aimed parallel to each other.

The droplet ejectors 102, 104 may be formed at a substrate 110 and such a substrate may have multiple layers. The substrate 110 may include silicon, glass, photoresist, conductive thin film, dielectric thin film, complementary metal-oxide-semiconductor (CMOS) structures or components, other types of electronic structures or devices to enable microfluidic operations, and similar materials. In other examples, the first droplet ejector 102 is formed in a first substrate and the second droplet ejector 104 is formed in a separate second substrate. Any number of droplet ejectors 102, 104 may be provided to a head, which may be referred to as a reagent dispenser or consumable, and such a device may employ inkjet droplet jetting techniques, such as thermal inkjet (TIJ) jetting.

The droplet ejectors 102, 104, the target medium 106, and the mixing body 108 may be integrated as a disposable cartridge or similar one-time-use consumable package. A substrate 110 that carries droplet ejectors 102, 104, the target medium 106, and the mixing body 108 may be permanently held together by adhesive, material deposition (e.g., deposition of photoresist onto a silicon substrate), interference or snap fit, over-molding, or similar technique.

The first droplet ejector 102 includes a first nozzle 112 to eject droplets of a first fluid into the mixing body 108. The second droplet ejector 104 includes a second nozzle 114 to eject droplets of a second fluid into the mixing body 108.

The first droplet ejector 102 may include a first jet element 116, such as a resistive heater, a piezoelectric element, or similar. The first jet element 116 may be controllable to draw first fluid from a first inlet 118 and through a first channel 120 that feeds the first droplet ejector 102, so as to jet droplets of the first fluid through the first nozzle 112, which may define an orifice or similar fluid output feature.

The second droplet ejector 104 may include a second jet element 122, such as a resistive heater, a piezoelectric element, or similar. The second jet element 122 may be controllable to draw second fluid from a second inlet 124 and through a second channel 126 that feeds the second droplet ejector 104, so as to jet droplets of the second fluid through the second nozzle 114, which may define an orifice or similar fluid output feature.

The first and second droplet ejectors 102, 104 may be independently controllable. That is, the first droplet ejector 102 may be operated at a frequency to provide a particular flow rate of first fluid droplets into the mixing body 108, while the second droplet ejector 104 may be operated at the same or different frequency to provide a particular flow rate of second fluid droplets into the mixing body 108. A flow rate may be dynamically controlled, in that it may be varied over time.

The first and second droplet ejectors 102, 104 may be the same or different. For example, the droplet ejectors 102, 104 may be the same or differ in nozzle size, nozzle shape, volume of ejected droplet, type or size of jet element (e.g., thermal resistor size), among other parameters.

The fluid provided to a droplet ejector 102, 104 may be a reagent, such as a chemical solution, a sample (e.g., a deoxyribonucleic acid or DNA sample), or other material. The term “fluid” is used herein to denote a material that may be jetted, such as aqueous solutions, suspensions, solvent solutions (e.g., alcohol-based solvent solutions), oil-based solutions, or other materials.

The fluids provided to the droplet ejectors 102, 104 may be different. For example, the first droplet ejector 102 may be provided with an acid and the second droplet ejector 104 may be provided with a base, and the droplet ejection rates may be controlled to provide a mixed solution having a target pH.

The fluids provided to the droplet ejectors 102 may be chemically, biologically, or biochemically similar, identical, or equivalent but may have a differing characteristic. Example differing characteristics include temperature, viscosity, surface tension, concentration of solids, concentration of surfactants, or similar. For example, the fluids may be the same aqueous solution at two different concentrations, and the droplet ejection rates may be controlled to provide a solution of a target concentration.

The target medium 106 is positioned to receive fluid ejected by the droplet ejectors 102, 104, as mixed in the mixing body 108. The target medium 106 may be immovably held with respect to the droplet ejectors 102, 104.

The target medium 106 may be provided with a reagent, sample, or similar material to undergo a biological, chemical, or biochemical process with a fluid mixture provided by the mixing body 108.

The target medium 106 may include a passive medium. Examples of passive target media include a strip or other structure of porous material, paper, foam, fibrous material, micro-fibers, and similar. A passive target medium may include a network of microfluidic channels, which may be made of silicon, photoresist (e.g., SU-8), polydimethylsiloxane (PDMS), cyclic olefin copolymer (COC), other plastics, glass, and other materials that may be made using micro-fabrication technologies. The fluid mixture delivered by the mixing body 108 may be conveyed by capillary action by a passive target medium. In other examples, a passive target medium may be non-porous. A passive medium may contain a fluid that receives droplets of ejected fluid. That is, droplets of an ejected fluid may be ejected into another fluid that is contained by a passive medium. Similarly, a passive medium may contain a solid compound that receives droplets of ejected fluid. A solid compound may be solid in bulk, may be a powder or particulate, may be integrated into a fibrous material, or similar.

The target medium 106 may include an active medium. Examples of active target media include a substrate having a mesofluidic or microfluidic structure. An active target medium may include an active microfluidic component, such as a pump, sensor, mixing chamber, channel, heater, reaction chamber, droplet ejector, or similar to perform further action on fluid mixture delivered by the mixing body 108.

The mixing body 108 may define an internal mixing volume 128 positioned between the first and second droplet ejectors 102, 104 and the target medium 106. The mixing volume 128 is to receive the droplets of the first fluid and the droplets of the second fluid from the respective droplet ejector 102, 104. The mixing volume 128 provides aerosol mixing of the droplets of the first and second fluids, and provides the resulting mixture to the target medium 106.

The mixing volume 128 provides a space for aerosol mixing, which includes a droplet of the first fluid combining with a droplet of the second fluid. Droplets may further undergo liquid mixing by, for example, coalescing on a surface, such as an interior surface 130 of the mixing body 108 or a surface or microfluidic structure of the target medium 106.

The mixing volume 128 may have a rectangular prismatic geometry, as depicted, or may have another geometry, such as non-rectangular prismatic, ovoid, spherical, conical, funnel-shaped, or similar. The mixing body 108 may be a funnel.

The mixing volume 128 may contain a gas, such as air, nitrogen, or other gas that is compatible with the fluids to be mixed within the mixing volume 128. Such a gas may be selected to be inert to the mixing or to aid the mixing. The mixing volume 128 may be hermetically sealed or may be provided with a one-way vent to relieve pressure contained therein.

The mixing volume 128 may be considered mesofluidic in scale, whereas the droplet ejectors, droplets, and related components may be considered microfluidic in scale. As an ejected droplet may have a volume on the order of picolitres, effective mixing may be possible in a relatively small mixing volume 128. A large number of droplet ejectors may be provided to increase flow of mixed fluid.

In operation, a first fluid is drawn through the first channel 120 and ejected into the mixing volume 128 by the first droplet ejector 102. Simultaneously, at the same or different rate, a second fluid is drawn through the second channel 126 and ejected into the mixing volume 128 by the second droplet ejector 104. Ejected droplets of the fluids undergo aerosol mixing within the mixing volume 128, and may further undergo liquid mixing, and a resulting mixture is deposited on the target medium 106.

The device 100 may allow for on-demand delivery of mixtures to the target medium 106. For example, in a polymerase chain reaction (PCR) application, an optimal pH of a lysis buffer may vary from target sequence to target sequence by one or two units. Also, there may be a great variability of sample types. For example, fungi may require a different pH of lysis buffer than gram-positive bacteria. By preloading the device 100 with constituent reagents, delivery of an optimal lysis buffer for a particular target sequence may be realized by appropriate control of the droplet ejectors 102, 104. As such, the device 100 may be usable in a wide variety of applications.

Other example applications of the device 100 include preparation of mixtures for a real-time or quantitative polymerase chain reaction (qPCR), reverse transcription polymerase chain reaction (RT-PCR), loop mediated isothermal amplification (LAMP), and similar processes.

FIG. 2 shows an example device 200. Features and aspects of the other devices and systems described herein may be used with the device 200 and vice versa. Like reference numerals denote like elements and description of like elements is not repeated here.

The device 200 includes a first fluid volume 202 to supply a first fluid 204 to a first droplet ejector 102. The device 200 further includes a second fluid volume 206 to supply a second fluid 208 to a second droplet ejector 104.

The device 200 may include a first fluid reservoir 210 to define the first fluid volume 202. The first fluid reservoir 210 may be in communication with a first inlet 118 of a first channel 120 that feeds the first droplet ejector 102. The first fluid reservoir 210 may include an end region of a slot in a substrate 110 that carries the first droplet ejector 102, and such a slot may convey fluid from a user-fillable or factory-fillable reservoir, fill cup, or similar volume to the first channel 120 of the first droplet ejector 102.

Similarly, the device 200 may include a second fluid reservoir 212 to define the second fluid volume 206. The second fluid reservoir 212 may be in communication with a second inlet 124 of a second channel 126 that feeds the second droplet ejector 104. The second fluid reservoir 212 may be structurally analogous, similar, or identical to the first fluid reservoir 210.

The device 200 may be preloaded with the first fluid 204 in the first fluid volume 202. The first fluid volume 202 may be filled at time of manufacture. Similarly, the device 200 may be preloaded with the second fluid 208 in the second fluid volume 206. As such, the device 200 may be a ready-to-use consumable device.

A fluid reservoir 210, 212 may include a fill port to allow filling of fluid after manufacture, just prior to use, or in similar situations. For example, the device 200 may provide for the analysis of a biological sample and a fill port may be used to provide the sample to the device 200. In this example, the second fluid reservoir 212 includes a fill port 214 to receive the second fluid 208 from an external source, such as a pipette, syringe, or other fluid delivery device. The fill port 214 may include a closure to reduce a risk of intrusion of contaminants. Example closures include a cap, self-sealing membrane, and similar.

Further, as illustrated by way of dashed lines, first and second nozzles 112, 114 of the first and second droplet ejectors 102, 104 are aimed parallel to each other. Although streams of droplets of the first and second fluids 204, 208 may initially be parallel, the droplets may rapidly disperse and mix within an internal mixing volume 128 prior reaching the target medium 106.

A fluid reservoir 210, 212 may include a vent 216 to allow outside air or other gas to enter the fluid reservoir 210, 212 as fluid is ejected, so as to relieve negative pressure that may be caused by fluid being drawn from the respective fluid reservoir 210, 212. The vent 216 may include an opening, a permeable membrane, a bubbler, or similar structure that may resist the intrusion of outside contaminants while allowing for pressure equalization. A fill port 214 may act as a vent.

A mixing body 108 may include a vent 218 to relieve positive pressure that may develop due to fluid being ejected into the internal mixing volume 128. The vent 218 of the mixing body 108 may be similar or identical in structure to a vent 216 at a fluid reservoir 210, 212.

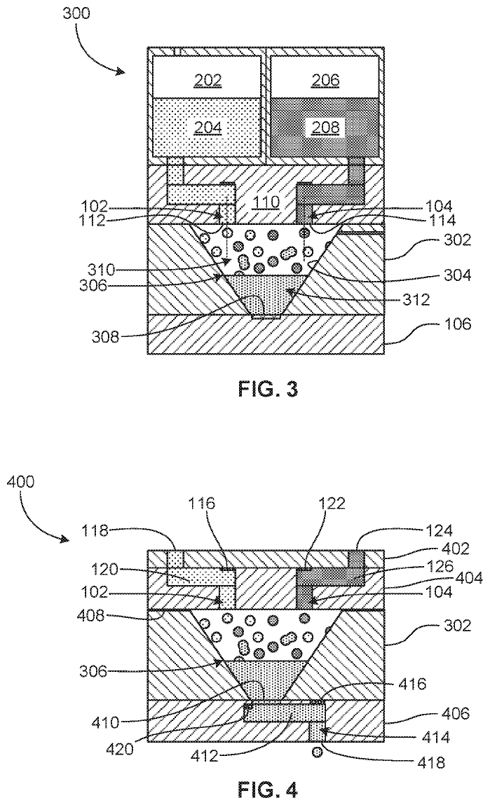

FIG. 3 shows an example device 300. Features and aspects of the other devices and systems described herein may be used with the device 300 and vice versa. Like reference numerals denote like elements and description of like elements is not repeated here.

The device 300 includes a funnel 302 disposed between first and second droplet ejectors 102, 104 and a target medium 106. The funnel 302 may be considered a mixing body that defines an internal mixing volume.

The funnel 302 may include an internal funnel surface 304 that defines an internal mixing volume 306. In the view shown, two opposing funnel surfaces 304 are depicted. A funnel surface 304 may be flat or curved and may generally narrow from a substrate 110 that carries droplet ejectors 102, 104 towards a target medium 106. That is, the funnel 302 may be sufficiently wide in the vicinity of the droplet ejectors 102, 104 to collect and guide fluid droplets and may narrow towards the target region 308. The funnel may or may not be symmetrical.

The funnel surface 304 may guide droplets in flight and may guide flow of coalesced droplets as liquid towards the target region 308. The mixture provided by mixing of fluids ejected by the droplet ejectors 102, 104 may include bulk liquid and the funnel 302 may guide the flow of such liquid to the target region 308.

The mixing volume 306 of the funnel 302 may under operation divide into an aerosol mixing volume 310 and a liquid mixing volume 312. That is, as droplets coalesce, the mixing volume 306 may begin to fill with liquid, leaving a portion of the mixing volume 306 to provide for aerosol mixing of droplets.

FIG. 4 shows an example device 400. Features and aspects of the other devices and systems described herein may be used with the device 400 and vice versa. Like reference numerals denote like elements and description of like elements is not repeated here.

The device 400 includes first and second droplet ejectors 102, 104 formed by fluid channels within substrates 402, 404. A first substrate 402 may be a silicon substrate provided with first and second inlets 118, 124. First and second jet elements 116, 122 may be formed on the first substrate 402. A second substrate 404 may be a photoresist layer that is deposited on the first substrate 402. The second substrate 404 may form first and second channels 120, 126 to feed the first and second droplet ejectors 102, 104.

The device 400 may further include a funnel 302 or other mixing body and a target medium 406. The funnel 302 may be positioned between the droplet ejectors 102, 104 and the target medium 406.

The funnel 302 may be formed from a silicon substrate that is attached to the second substrate 404 by an adhesive 408 or similar technique.

The target medium 406 may include a photoresist layer that is deposited on the silicon substrate that forms the funnel 302. The target medium 406 may include a target region that may include a third inlet 410 to feed mixed fluid received from the funnel 302 to a third channel 412 that feeds a third droplet ejector 414 formed in the target medium 406. The third droplet ejector 414 may include a third jet element 416 deposited on the silicon substrate that forms the funnel 302 and a third nozzle 418 defined by an orifice in the layer that forms the target medium 406. As such, the target medium 406 includes a third droplet ejector 414 to receive a mixture from a mixing volume 306 defined by the funnel 302, the mixture resulting from the mixing of droplets of fluid ejected by the first and second droplet ejectors 102, 104. The third droplet ejector 414 may be driven to eject droplets of the mixture from the target medium 406 to, for example, another target medium.

The device 400 may include a sensor 420 located at the target medium 406, for example, in the third channel 412. The sensor 420 may be to detect the presence or a characteristic of mixed fluid in the third channel 412. The sensor 420 may be used to tune the driving of the first and second droplet ejectors 102, 104. For example, the sensor 420 may be a pH sensor and a target pH value may be referenced to drive the first and second droplet ejectors 102, 104.

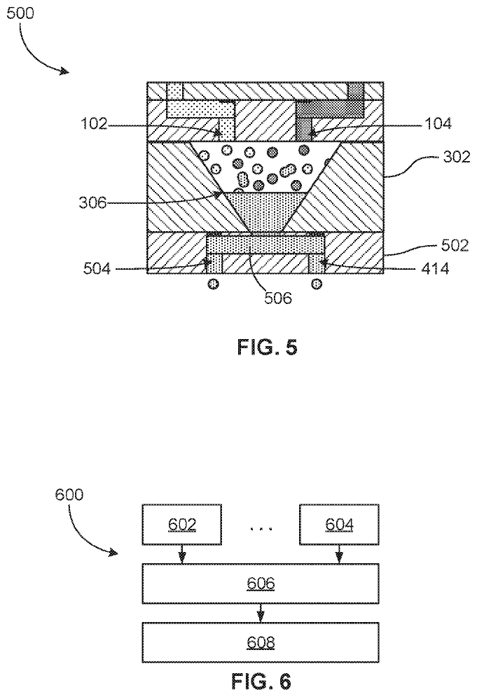

FIG. 5 shows an example device 500. Features and aspects of the other devices and systems described herein may be used with the device 500 and vice versa. Like reference numerals denote like elements and description of like elements is not repeated here.

The device 500 includes a target medium 502 including a plurality of third droplet ejectors 504, 414 in communication with a common channel 506 that is fed by a mixing volume 306 of a funnel 302 or other mixing body. First and second droplet ejectors 102, 104 may deliver droplets of fluid to the mixing volume 306 and the resulting mixture may be fed to the plurality of third droplet ejectors 504, 414 to be ejected from the target medium 502 to, for example, another target medium. The number of third droplet ejectors 504, 414 may be selected to achieve a target ejection rate of mixed fluid.

FIGS. 6-9 schematically illustrate further example devices. Features and aspects of the other devices and systems described herein may be used with the devices shown and vice versa. Like reference numerals denote like elements and description of like elements is not repeated.

FIG. 6 shows an example device 600 that includes a plurality of droplet ejectors 602, 604 to eject droplets of a plurality of fluids into a mixing body 606. The mixing body 606 is positioned between the droplet ejectors 602, 604 and a target medium 608. The mixing body 606 mixes droplets of the fluids provided by the plurality of droplet ejectors 602, 604 and provides a mixture to the target medium 608. The device 600 may be considered a single-stage mixing unit and may be considered a schematic representation of the devices of FIGS. 1-5.

The target medium 608 may include a droplet ejector to feed a subsequent stage of mixing.

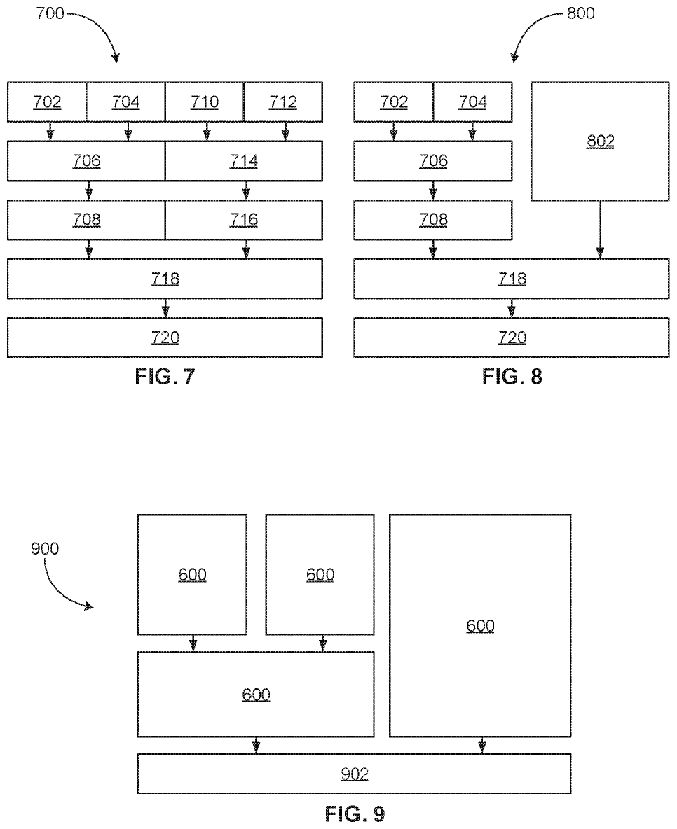

FIG. 7 shows an example device 700 that includes two stages of mixing. In other examples, three or more stages of mixing may be provided.

The device 700 that includes a first plurality of droplet ejectors 702, 704 to eject droplets of a plurality of fluids into a first mixing body 706. The first mixing body 706 is positioned between the first plurality of droplet ejectors 702, 704 and a first target medium 708. The first mixing body 706 mixes droplets of the fluids provided by the first plurality of droplet ejectors 702, 704 and delivers a first mixture to the first target medium 708.

The device 700 further includes a second plurality of droplet ejectors 710, 712 to eject droplets of a plurality of fluids into a second mixing body 714. The second mixing body 714 is positioned between the second plurality of droplet ejectors 710, 712 and a second target medium 716. The second mixing body 714 mixes droplets of the fluids provided by the second plurality of droplet ejectors 710, 712 and delivers a second mixture to the second target medium 716.

The first and second target media 708, 716 include a plurality of droplet ejectors to eject droplets of the first and second mixtures to a third mixing body 718. The third mixing body 718 is positioned between the first and second target media 708, 716 and a third target media 720. The third mixing body 718 mixes droplets of the fluids provided by the droplet ejectors of the first and second target media 708, 716 and delivers a third mixture to the third target medium 720.

The third target medium 720 may include a droplet ejector to feed an additional stage of mixing.

FIG. 8 shows an example device 800 that includes different stages of mixing. In this example, two-stage mixing is combined with one-stage mixing. In other examples, different numbers of stages may be combined.

The device 800 that includes a first plurality of droplet ejectors 702, 704 to provide a first mixture to a first target medium 708 through a first mixing body 706. The first target medium 708 includes a plurality of droplet ejectors to eject droplets of the first mixture to a third mixing body 718.

The device 800 further includes a second plurality of droplet ejectors 802 to eject droplets of a second fluid directly to the third mixing body 718.

The third mixing body 718 mixes droplets of the first mixture and the second fluid and delivers a resulting third mixture to a third target medium 720.

FIG. 9 shows an example device 900 that includes a plurality of single-stage mixing units 600 arranged in combination to form a complex multi-stage mixing structure to feed a resulting mixture to a final target medium 902. Various mixing structures may be formed using any number and arrangement of mixing units 600.

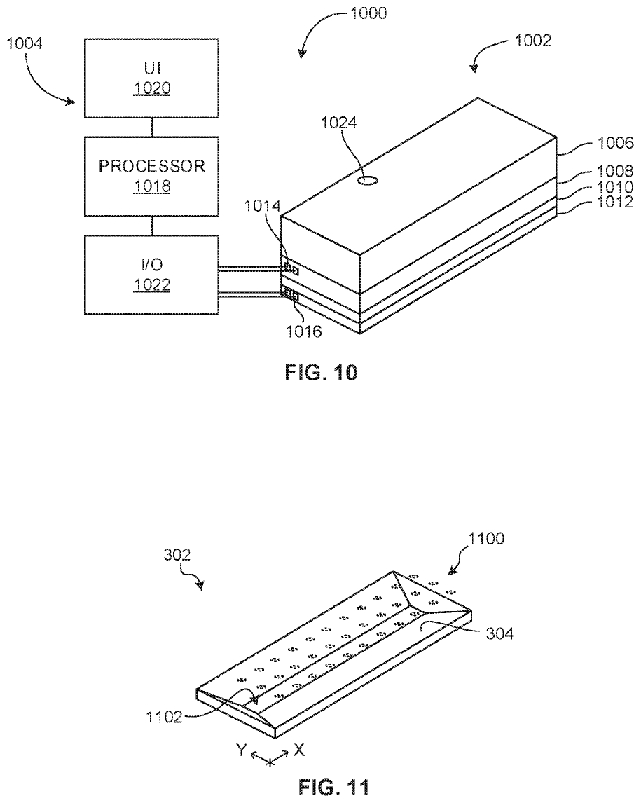

FIG. 10 shows an example system 1000. Features and aspects of the other devices and systems described herein may be used with the system 1000 and vice versa. Like reference numerals denote like elements and description of like elements is not repeated here.

The system includes a cartridge 1002 and a control device 1004. The cartridge 1002 may be a disposable cartridge that may be discarded after use.

The disposable cartridge 1002 may be similar or identical to any of the devices described elsewhere herein. The disposable cartridge 1002 may include a plurality of fluid reservoirs 1006, a substrate 1008, a mixing body 1010, and a target medium 1012. The fluid reservoirs 1006 may feed fluids to a plurality of droplet ejectors at the substrate 1008. The droplet ejectors may eject droplets of fluid into the mixing body 1010 so as to provide a mixed fluid to the target medium 1012. The mixing body 1010 may include a funnel or similar structure. Any quantity and combination of mixing stages may be provided.

A terminal 1014 may be provided to the substrate 1008 to connect jet elements of the droplet ejectors to the control device 1004. The control device 1004 may provide a drive signal to the terminal 1014 to drive the droplet ejectors at the substrate 1008 to eject fluid droplets into the mixing body 1010.

A terminal 1016 may be provided to the target medium 1012 to connect a sensor at the target medium 1012 to the control device 1004. The control device 1004 may receive from the terminal 1016 a measurement signal indicative of a process carried out at the disposable cartridge 1002.

The control device 1004 may include a processor 1018, a user interface 1020, and an input/output interface 1022.

The user interface 1020 may be connected to the processor 1018 and may include a display, touchscreen, keyboard, or similar to provide output to a user and receive input from the user.

The input/output interface 1022 may be connected to the processor 1018 to provide signal communications between the disposable cartridge 1002 and the processor 1218. The input/output interface 1022 may receive a removeable connection to the terminals 1014, 1016 of the disposable cartridge 1002.

The processor 1018 may include a central processing unit (CPU), a microcontroller, a microprocessor, a processing core, a field-programmable gate array (FPGA), and/or similar device capable of executing instructions. The processor 1018 may cooperate with a non-transitory machine-readable medium that may be an electronic, magnetic, optical, and/or other physical storage device that encodes executable instructions. The machine-readable medium may include, for example, random access memory (RAM), read-only memory (ROM), electrically-erasable programmable read-only memory (EEPROM), flash memory, a storage drive, an optical disc, and/or similar.

The processor 1018 may control the disposable cartridge 1002 to carry out its function by controlling a number of droplet ejectors to activate, a time of droplet ejection by a droplet ejector, a frequency of droplet ejection of a droplet ejector, a combination of such, or similar. The processor 1018 may execute a mixing program by selectively driving droplet ejectors. The processor 1018 may receive output of the process carried out at the disposable cartridge 1002 as a signal that may be used to further control the process at the disposable cartridge 1002 or that may be outputted to the user at the user interface 1020.

Control of mixture production may be dynamic or time dependent. That is, the processor 1018 may vary droplet ejector output over time. For example, a pH may be set higher at the beginning of a process then gradually lowered toward the end of the process.

The control device 1004 may control the functionality of a variety of different disposable cartridges 1002.

The control device 1004 may include a mechanical feature to removably mechanically receive a disposable cartridge 1002 by way of a mating mechanical feature at the disposable cartridge 1002.

A fluid reservoir 1006 of the disposable cartridge 1002 may be preloaded with a fluid. A fluid reservoir 1006 of the disposable cartridge 1002 may include a fill port 1024 to receive a fluid from an external source, such as a pipette, syringe, or other fluid delivery device. For example, a generic cartridge may be provided for wide range of usage. Then, a particular end user may add their particular fluid of interest to such a cartridge or may control mixing for their particular application.

FIG. 11 shows a perspective view of an example funnel 302 showing an array of droplet ejector nozzles 1100. As shown, the funnel 302 may be used to collect and mix fluid ejected from a plurality of droplet ejectors and direct the resulting mixture to a funnel outlet 1102 that may be positioned at a target region of a target medium.

The funnel 302 may be particularly useful in collecting droplets ejected by the array of droplet ejector nozzles 1100, which may not all be aimed directly towards a target region on a target medium.

The array of droplet ejector nozzles 1100 may be situated in an XY plane defined by the substrate in which the droplet ejectors are formed. A pitch of droplet ejectors in either or both the X and Y directions may be limited by manufacturing constraints. A target maximum flow rate of fluid for a device as a whole may be achieved by increasing a number of droplet ejectors and decreasing ejector spacing to an extent possible. Each droplet ejector may have its own maximum flow rate for a given fluid and a total flow capacity may be determined by summing the individual maximum flow rates for a plurality of ejectors. A particular group of nozzles, such as a row of nozzles in the X direction, may be connected to a particular fluid reservoir. As such, maximum flow rate of a particular fluid may be selected by selecting the number of connected nozzles. A ratio of maximum flow rates of different fluids may correspond to a ratio of the number of respective nozzles providing such fluids. Relatively large-scale mixing may be achieved by using a suitable number of nozzles.

A group of nozzles connected to the same fluid reservoir may be arranged in a row along an X axis, in a row along an Y axis, in a square or other geometry in the XY plane, or similar. This may be useful when mixing different volumes of fluids, particularly when the different volumes differ greatly. For instance, a single nozzle that ejects a first fluid may be surrounded by a square arrangement of eight nozzles that eject a second fluid, and this may provide a nominal 8-to-1 mixing ratio.

In view of the above, it should be apparent that aerosol mixing of different droplet streams provides for effective mixing upstream of a target medium. Reliance on the target medium to carry out mixing may be reduced or eliminated. Further, effective mixing for microfluidic applications may be performed at mesofluidic volumes with no moving parts by way of a funnel or similar mixing body. A relatively large mixing volume (e.g., a few hundred microliters to a milliliter) may be incorporated on a relatively small integrated device (e.g., a device with picolitre scale nozzles). Further, the ability to fine-tune reagents on demand reduces or eliminates the need to preload optimal compositions. For example, instead of using different fluid delivery devices for processes concerning bacteria, fungi, mammalian cells, plant cells, and so forth, partial universality of sample preparation reagents may be achieved. That is, buffers for lysis, DNA binding, washing, and elution may be provided in premixed form to be mixed by the end user depending on the particular application. In addition, handling of unstable reagents may be simplified in that separate constituents that are stable may be mixed on demand just before use.

It should be recognized that features and aspects of the various examples provided above can be combined into further examples that also fall within the scope of the present disclosure. In addition, the figures are not to scale and may have size and shape exaggerated for illustrative purposes.

1. A device comprising:
a first droplet ejector including a first nozzle to eject droplets of a first fluid;
a second droplet ejector including a second nozzle to eject droplets of a second fluid;
a target medium; and
a mixing volume positioned between the first and second droplet ejectors and the target medium, wherein the mixing volume is to receive the droplets of the first fluid and the droplets of the second fluid, provide aerosol mixing of the droplets of the first fluid and the droplets of the second fluid, and provide a mixture to the target medium.

2. The device of claim 1, wherein the second nozzle is aimed parallel to the first nozzle.

3. The device of claim 1, further comprising a funnel disposed between the first and second droplet ejectors and the target medium, wherein the mixture includes liquid and the funnel is to guide flow of the liquid to a target region on the target medium.

4. The device of claim 1, wherein the target medium includes a third droplet ejector to receive the mixture from the mixing volume, the third droplet ejector including a third nozzle to eject droplets of the mixture.

5. The device of claim 1, further comprising a first fluid volume to supply the first fluid to the first droplet ejector and a second fluid volume to supply the second fluid to the second droplet ejector.

6. The device of claim 5, further comprising the first fluid preloaded in the first fluid volume.

7. The device of claim 5, further comprising a fill port to receive the second fluid from an external source.

8. The device of claim 1, wherein the mixing volume contains a gas.

9. The device of claim 1, wherein the first droplet ejector, the second droplet ejector, the target medium, and the mixing volume are integrated as a disposable cartridge.

10. A disposable cartridge comprising:
a first droplet ejector including a first nozzle to eject droplets of a first fluid;
a second droplet ejector including a second nozzle to eject droplets of a second fluid;
a target medium; and
a mixing volume positioned between the first and second droplet ejectors and the target medium, wherein the mixing volume is to receive and mix the droplets of the first fluid and the droplets of the second fluid, and provide a mixture to the target medium.

11. The disposable cartridge of claim 10, further comprising a first fluid reservoir to contain the first fluid and provide the first fluid to the first droplet ejector.

12. The disposable cartridge of claim 11, further comprising the first fluid preloaded in the first fluid reservoir.

13. The disposable cartridge of claim 10, further comprising a second fluid reservoir to contain the second fluid and provide the second fluid to the second droplet ejector, the disposable cartridge further comprising a fill port at the second fluid reservoir to receive the second fluid from an external source.

14. The disposable cartridge of claim 10, wherein the target medium includes a third droplet ejector to receive the mixture from the mixing volume, the third droplet ejector including a third nozzle to eject droplets of the mixture.

15. A device comprising:
a substrate carrying a plurality of droplet ejectors to eject droplets of different fluids;
a funnel to receive the droplets of different fluids from the plurality of droplet ejectors and to mix the droplets of different fluids; and
a target medium to receive a mixture of the different fluids from the funnel.
